(19) United States
(12) Patent Application Publication
(10) Pub. No.: US 2011/0252215 A1
(43) Pub. Date: Oct. 13, 2011

(54) COMPUTER MEMORY WITH DYNAMIC CELL DENSITY

(75) Inventors: Michele M. Franceschini, White Plains, NY (US); John P. Karidis, Ossining, NY (US); Luis A. Lastras-Montano, Cortlandt Manor, NY (US); Moinuddin Qureshi, White Plains, NY (US)

(73) Assignee: INTERNATIONAL BUSINESS MACHINES CORPORATION, Armonk, NY (US)

(21) Appl. No.: 12/757,738

(22) Filed: Apr. 9, 2010

(51) Int. Cl. G06F 12/02

(52) U.S. Cl. 711/170; 711/E12.002

(57) ABSTRACT

A computer memory with dynamic cell density including a method that obtains a target size for a first memory region. The first memory region includes first memory units operating at a first density. The first memory units are includes in a memory in a memory system. The memory is operable at the first density and a second density. The method also includes: determining that a current size of the first memory region is not within a threshold of the target size and that the first memory region is smaller than the target size; identifying a second memory unit currently operating at the second density in a second memory region, the second memory unit included in the memory; and dynamically reassigning, during normal system operation, the second memory unit into the first memory region, the second memory unit operating at the first density after being reassigned to the first memory region.

### BACKGROUND

This present invention relates generally to computer memory, and more specifically, to computer memory with dynamic cell density.

Phase-change memories (PCMs) are limited life memory devices that exploit properties of chalcogenide glass to switch between two states, amorphous and crystalline, with the application of heat using electrical pulses. Data is stored in PCM devices in the form of resistance, the amorphous phase has high electrical resistivity and the crystalline phase has low resistance. The difference in resistance between the two states is typically three orders of magnitude. To achieve high density, PCMs memories are expected to exploit this high resistance range to store multiple bits in a single cell, forming what is known as multi-level cell (MLC) devices. The density advantage of PCM is, in part, dependent on storing more and more bits in the MLC devices. Multi-level write algorithms for PCM are described in “Write strategies for 2 and 4-bit multi-level phase-change memory,” by T. Nirschl, et. al, IEEE International Electron Devices Meeting, 2007, IEDM 2007, which is hereby incorporated by reference herein in its entirety.

While MLC devices offer more density than devices that store one bit per cell (referred to as single-level cell or “SLC” devices), this advantage comes at a price. MLC devices require precise reading of the resistance values stored in the memory cells. The maximum number of bits that can be stored in a given MLC device is a function of precision in reading technology, device data integrity, and precision in writing. The number of levels in a MLC device increases exponentially with the number of bits stored, which implies that the resistance region assigned to each data value decreases very significantly. For example, in a four-bit per cell device, the resistance range is divided so as to encode sixteen levels, and reading the data stored in the cell requires accurately differentiating between the sixteen resistance ranges.

The read latency of MLC devices, depending on the sensing amplifier technology, can increase linearly or exponentially with the number of bits stored in each cell. Reading a data value from a MLC device requires distinguishing precisely between different resistance levels that are spaced closely together.

In MLC devices, each data value is assigned a limited resistance range, which means that the writing process must be accurate enough to program a specified narrow range of resistance. Typically, the increased programming precision is obtained by means of iterative write algorithms that contain several steps of read-verify-write operations. The number of iterations required for writing increases with the number of bits per cell. Thus, with more bits per cell, these algorithms will cause an increased write latency, will consume increasingly more write energy, and will exacerbate the limited lifetime of PCM memories.

### SUMMARY

An exemplary embodiment is a computer implemented method for performing in a memory system. The method includes obtaining a target size for a first memory region. The first memory region includes first memory units operating at a first density. The first memory units are includes in a memory in a memory system. The memory is operable at the first density and operable at a second density. The method also includes: determining that a current size of the first memory region is not within a threshold of the target size and that the first memory region is smaller than the target size; identifying a second memory unit currently operating at the second density in a second memory region, the second memory unit included in the memory; and dynamically reassigning, during normal system operation, the second memory unit into the first memory region, the second memory unit operating at the first density after being reassigned to the first memory region.

Another exemplary embodiment is a computer system that includes: a memory capable of accessing data at two or more densities; and a memory management subsystem for organizing the memory into at least two memory regions operating at different densities. The memory management subsystem receives memory access requests from a processing unit and is configured to dynamically change the size of at least one of the memory regions during normal system operation in response to characteristics of a program that is executing on the processing unit.

A further exemplary embodiment is a computer program product for performing memory management. The computer program product includes a tangible storage medium readable by a processing circuit and storing instructions for execution by the processing circuit for performing a method. The method includes obtaining a target size for a first memory region. The first memory region includes first memory units operating at a first density. The first memory units are includes in a memory in a memory system. The memory is operable at the first density and operable at a second density. The method also includes: determining that a current size of the first memory region is not within a threshold of the target size and that the first memory region is smaller than the target size; identifying a second memory unit currently operating at the second density in a second memory region, the second memory unit included in the memory; and dynamically reassigning, during normal system operation, the second memory unit into the first memory region, the second memory unit operating at the first density after being reassigned to the first memory region.

A further exemplary embodiment is a computer implemented method for performing memory management in a memory system. The method includes obtaining a target size for a first memory region in a memory that is capable of accessing data at two or more densities. The first memory region includes a first portion of the memory operating at a first density. The obtaining a target size includes performing for a plurality of possible first memory region sizes: estimating a probability of a processor request not being present in the memory; and estimating a performance characteristic of the memory system in response to a latency of the first portion of the memory, a latency of a second portion of the memory, and the estimated probability of the processor request not being present in the memory. The target size is selected from the plurality of possible first memory region sizes; the target size selected corresponds to a possible first memory region size having the highest estimated performance characteristic among the plurality of possible first memory region sizes.

Additional features and advantages are realized through the techniques of the present embodiment. Other embodiments and aspects are described herein and are considered a part of the claimed invention. For a better understanding of the invention with the advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a block diagram of a system for storing and retrieving data in a memory system that may be implemented by an exemplary embodiment;

FIG. 2 illustrates a process for implementing a morphable memory system (MMS) that may be implemented by an exemplary embodiment;

FIG. 3 illustrates a process for accessing memory in a MMS that may be implemented by an exemplary embodiment;

FIG. 4 illustrates a process for reaching a target percentage of lower density memory cells that may be implemented by an exemplary embodiment;

FIG. 5 illustrates a process for upgrading a memory page that may be implemented by an exemplary embodiment; and

FIG. 6 illustrates a process for downgrading a memory page that may be implemented by an exemplary embodiment.

### DETAILED DESCRIPTION

An exemplary embodiment of the present invention monitors the usage of individual memory regions and estimates the memory capacity requirement of a given application (or application mix) executing on a computer system. This information is utilized to regulate densities of PCM cells in order to meet changing memory capacity requirements and to provide a high level of system performance and power efficiency.

Exemplary embodiments of the present invention provide a memory system where the number of bits per cell stored in phase change memory (PCM) devices is varied depending on current workload requirements. Such a memory system can obtain reduced latency, reduced power, and enhanced lifetime for the common case when a computer system does not fully use memory capacity by dynamically using fewer bits per cell. When a current workload is such that the system is constrained by memory capacity, an exemplary embodiment automatically increases the bits per cell (or density) of PCM devices to make the full memory capacity available to the system. Exemplary embodiments may be implemented without any user software changes.

The ability to vary the number of bits per cell dynamically provides the benefits of low density PCMs in the case where a reduced memory capacity is required while retaining memory capacity for applications that need all the memory capacity. For applications that are not capacity constrained, it is beneficial to have most of the memory storing fewer bits per cell; whereas for capacity intensive workloads it is better to have most (or all) of the memory storing a maximum number of bits per cell. Exemplary embodiments provide the ability to dynamically vary the number of bits per cell based on a current workload.

An exemplary embodiment, referred to herein as a “morphable memory system” or “MMS” divides the main memory into two regions. The first region is a high-density high-latency region that contains pages in multi-level cell (MLC) mode. Such a memory region is referred to herein as a “high-density PCM region” or “HDPCM region”. The second region is a low-latency low-density region that contains pages having fewer (e.g., half) the number of bits per cell than in the HDPCM region. Such a memory region is referred to herein as a “low-latency PCM region” or “LLPCM region”. As the percentage of total memory pages that are in LLPCM mode (i.e., those memory pages that are in the LLPCM region and store, for example, one bit per cell) increases, the likelihood of an access being satisfied by the LLPCM region increases, but at the expense of reduction in overall memory capacity. Thus, the key decision in MMS is to determine what fraction of all memory pages should be in LLPCM mode to optimally balance this latency and capacity trade-off. The memory pages within each region do not have to occupy contiguous locations in memory.

In exemplary embodiments, the memory cells are operated in two modes: a HDPCM mode which stores a multiple number of bits per cell up to the number permitted by the memory technology; and a LDPCM mode which stores fewer bits per cell than the memory cells operated in HDPCM mode. In an exemplary embodiment, the HDPCM mode stores two bits per cell and the LDPCM mode stores one bit per cell. In another exemplary embodiment, the HDPCM mode stores four bits per cell and the LDPCM mode stores two bits per cell. These are just two examples, other numbers of bits per cell and ratios between the HDPCM mode and the LDPCM mode may be implemented by exemplary embodiments.

An exemplary embodiment of the MMS includes a memory monitor (MMON) that tracks the workload memory requirements at runtime to determine a target partition between LLPCM and HDPCM regions.

In an exemplary embodiment, if a memory access occurs to a page in the HDPCM region, that page can be upgraded to the LLPCM region for lower latency on subsequent accesses. MMS allows such transfers between the HDPCM and LLPCM regions in order to automatically provide lower latency to frequently accessed pages. In an exemplary embodiment, such a transfer between the HDPCM region and the LLPCM region is handled transparently by the MMS hardware, without any involvement of software or the operating system (OS). A separate hardware structure, referred to herein as a “page redirection table” or PRT keeps track of the physical location of each page and is consulted on each memory access. Unlike conventional memory systems, in exemplary embodiments that implement MMS, the total memory capacity (in terms of number of pages) that is available to the OS can vary at runtime. In an exemplary embodiment, a hardware-OS interface is provided to facilitate this communication. This allows the OS to evict some of the allocated pages to make them available to the MMS hardware, if the number of pages in the LLPCM region is to be increased. When the demand for memory capacity increases, the hardware transfers pages from the LLPCM region to the HDPCM region, and the pages that are freed up can be reclaimed by the OS to accommodate other pages.

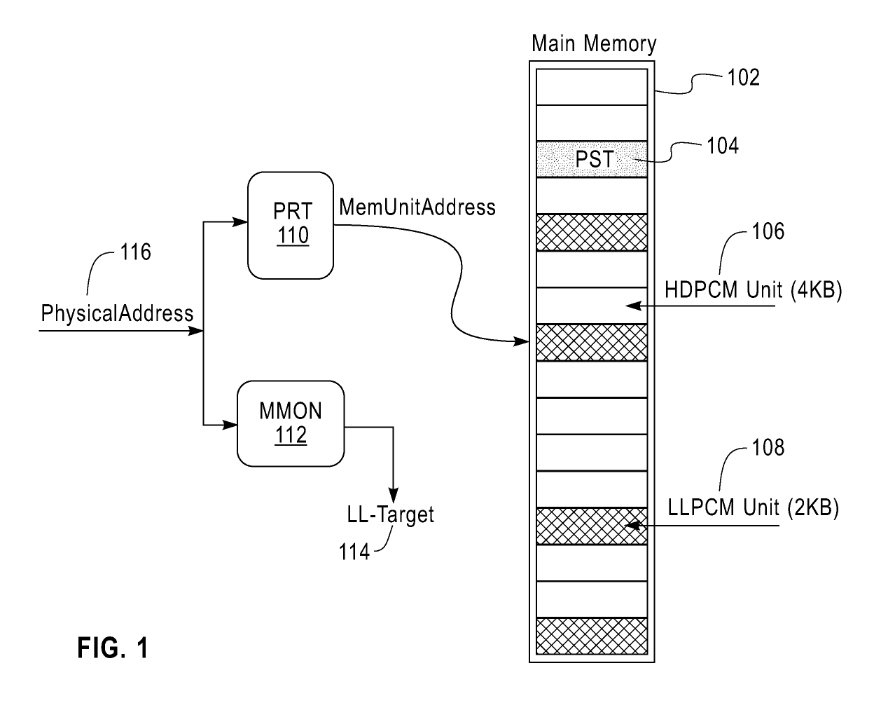

FIG. 1 depicts a block diagram of a MMS that may be implemented by an exemplary embodiment. The MMS depicted in FIG. 1 includes a main memory 102 that is arranged in terms of pages, each page having a maximum capacity of four kilobytes (4 KBs). 4 KB is a page size that is commonly used by operating systems (OSs). If an OS has a page size larger than 4 KB, then an exemplary embodiment of the MMS can manage the memory at a sub-page granularity of 4 KB. The use of a page size of 4 KB also allows the MMS to automatically handle heterogeneous page sizes, as long as each page size is a multiple of 4 KB. The examples described herein assume a page size of 4 KB, however, other page sizes are supported by exemplary embodiments.

As shown in FIG. 1, memory pages in the HDPCM region are referred to as HDPCM units 106 and memory pages in the LLPCM region are referred to as LLPCM units 108. In an exemplary embodiment, each HDPCM unit (or page) is used to store 4 KB of data and each LLPCM unit (or page) is used to store 2 KB of data.

In the exemplary embodiment depicted in FIG. 1, each page in the memory 102 is in one of two modes, either HDPCM mode (occupying one HDPCM unit 106) or LLPCM mode (occupying two LLPCM units 108). Pages in the memory 102 can support both of the modes and a given page may be in HDPCM mode at one point in time and in LLPCM mode at another point in time. The OS sees an addressable memory size as if each page occupies one memory unit, i.e., as if all pages are in HDPCM mode. In this way, there is a one to one relationship between addressable pages and memory units.

In an exemplary embodiment, the MMS conceptually divides the main memory 102 into two regions: a HDPCM region and a LLPCM region. The MMS includes a memory monitor (MMON) 112 to determine what fraction of memory pages should be in LLPCM mode in order to balance the latency and capacity trade-off.

The MMON 112 observes the traffic received by main memory 102 to estimate the capacity requirement of a current workload. In an exemplary embodiment, the MMON 112 performs estimation using the well-known stack distance histogram (SDH) analysis at runtime for a few sampled pages to estimate a page miss ratio curve. This information, along with an estimated benefit from accessing pages in the LLPCM region is used to determine a target partition between LLPCM and HDPCM regions. In an exemplary embodiment, the OS periodically (e.g., during normal system operation or runtime) consults the MMON 112 to obtain an estimate for a target partition, and in response to the target partition dynamically (e.g., during normal system operation or runtime) varies the number of pages in the LLPCM region. This target number of pages in the LLPCM region is referred to herein as a LL-target 114. As used herein, the phrase “normal system operation” refers to a system state when the system is in production operation and performing user functions (e.g., executing a business application program that requires access to the memory, transmitting data across a network, etc.), as well as common operating system tasks. Normal system operation may be characterized by a current workload. Normal system operation is distinguished (different) from system start up or system initiation and system testing.

In an exemplary embodiment, the LL-target 114 is expressed as a target fraction of the pages that should be operating in LLPCM mode. In an exemplary embodiment, the memory system is configured so that a given fraction of the pages in the memory 102 (LL-target 114 or “X”) are at two bits per cell and a corresponding fraction (one minus LL-target 114 or “1−X”) are at four bits per cell. In an exemplary embodiment, in order to reduce hardware overhead, the memory 102 is divided into groups of pages (e.g., 32 pages, 64 pages) in which the LL-target 114 is enforced.

When a page is accessed in HDPCM mode, it can be upgraded to LLPCM mode for lower latency. Such an upgraded page will occupy two LLPCM memory units 108. In an exemplary embodiment, the first half of the upgraded page is resident in its corresponding memory unit. A separate hardware structure, a page redirection table (PRT) 110, provides the physical location of the second half of the pages that are in LLPCM mode. In an exemplary embodiment, each entry in the PRT 110 contains information about if the page is in HDPCM mode or LLPCM mode. If the page is in LLPCM mode, then the entry in the PRT 110 includes a pointer to the memory location where the second half of the page is located. In this manner, an incoming physical address 116 from a processor chip gets translated into a memory unit address so that the appropriate memory location can be accessed. In an exemplary embodiment, each physical address 116 that is received by the MMS system is converted into a memory unit address using the PRT 110. In some cases, such as those where the corresponding memory unit is an HDPCM unit 106, the physical address 116 may be the same as the memory unit address.

Given that some of the pages in memory 102 can be in LLPCM mode, the number of pages usable by the OS is reduced. Furthermore, for correctness reasons, the OS must ensure that it does not allocate a memory unit (e.g., a memory page) that is storing the second half of another page in LLPCM mode. This hardware-OS interface is accomplished by a memory mapped table, called a page status table (PST) 104. The PST 104 contains information about which units are usable by the OS, and which units are available as placeholders for the second halves of LLPCM pages. In an exemplary embodiment, the PST 104 contains the status for each page in the memory 102; the status can be one of four states: a normal OS page, a monitor page used my MMON 112, a LLPCM unit available to store the second half of a LLPCM, and a LLPCM unit that is currently storing the second half of a LLPCM.

The MMON 112 tracks the memory reference stream (e.g., accesses to the memory pages) to estimate a memory hit rate for different sizes of memory. Based on these estimates of the statistics of the memory usage, the MMON 112 sets a target for the fraction of LLPCM pages (the LL-target 114). In an exemplary embodiment, this is done using the stack distance histogram (SDH) analysis. To reduce the hardware overhead only a small fraction of randomly selected memory regions are used for the purpose of monitoring. In an exemplary embodiment the MMON 112 is conceptually organized as a two dimensional table containing 16-64 columns. The rows are selected based on the physical address 116. Each row has its own least recently used (LRU) management scheme that maintains the recency ordering for the different columns in each row. In addition, there is a set of global counters (16-64) that keeps track of how frequently each recency location is accessed. When a particular column within a row is accessed, the counter associated with that recency position is incremented and that column is updated to most recently used (MRU).

In an exemplary embodiment, the system (e.g., upon each page access) reads the frequency usage information associated with pages and whenever a page crosses a frequency threshold and it is in HDPCM mode, it is marked for reconversion to LLPCM mode. A HDPCM page in the LRU position in the same group is selected for swapping with the LLPCM page and one of the following is performed: swapping the addresses in the PRT 110 and swapping the contents; or reconfiguring the HDPCM page to a LLPCM page and one of the two component subpages of the selected LLPCM page is reconfigured to a HDPCM page, the PRT 110 is updated accordingly and the contents are swapped.

Thus, FIG. 1 depicts an exemplary embodiment of a memory capable of accessing data (e.g., reading, writing) at two or more densities. A memory management subsystem (e.g., a morphable memory system) organizes the memory into at least two regions (e.g., HDPCM region and LLPCM region) operating at different densities. The memory management subsystem receives memory access requests (e.g., the physical address 116) from a processing unit that is executing one or more programs. The memory management subsystem dynamically (e.g., during normal system operation) changes the size of at least one of the regions based on characteristics of the programs that are executing on the processing unit. The MMON 112 tracks the memory access requests and uses this data to determine a target size of at least one of the regions.

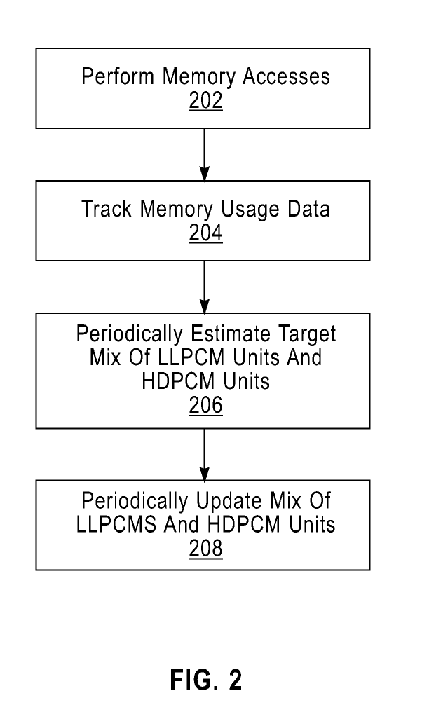

FIG. 2 illustrates a process for implementing a morphable memory system (MMS) that may be implemented by an exemplary embodiment. As depicted in FIG. 2, memory accesses are performed (e.g., in response to requests from a processor executing a program) at block 202 and memory usage data is tracked at block 204 by the MMOM 112. At block 206, the MMOM 112 periodically estimates a target mix of LLPCM units 108 and HDPCM units 106 in the memory 102. The result of the estimating is output as the LL-target 114. In an exemplary embodiment, dynamic partitioning is performed by the OS. In an exemplary embodiment, the counters in the MMON 112 are read periodically (e.g., every 250 milliseconds (ms)) to estimate the increase in execution time due to page faults and the reduction in execution time due to low latency LLPCM hits. This data is input to determining the LL-target 114.

Periodically, the counters in the MMON 112 are accessed to estimate the increase in page fault if a particular proportion of memory 102 is converted from HDPCM units 106 to LLPCM units 108. This process is also referred to herein as estimating a probability of a processor request not being present in memory, the estimating performed for a plurality of possible memory region sizes. In exemplary embodiments, the counters that are accessed are the counters corresponding to the LRU positions. This count is multiplied by average page fault latency to compute the increase in execution time due to more page faults. The space thus saved can be used to convert some pages from HDPCM units 106 to LLPCM units 108 and memory accesses to those pages would have reduced latency. The reduction in execution time due to this effect can be calculated by multiplying the number of memory accesses to the LLPCM region by the difference in latency of memory cells in HDPCM units 106 versus the latency of memory cells in LLPCM units 108. This process is also referred to herein as estimating a performance characteristic (here the characteristic is latency) of the memory system. The counters corresponding to the MRU position(s) correspond to the number of accesses that are satisfied by LLPCM units 108. In an exemplary embodiment, the partitioning is evaluated for 16-32 possible values of the proportion, P, and the one that has the best performance (Pbest) is selected as the proportion of memory to be in LLPCM mode until the next reconfiguration. Thus, a target size of a memory region is selected from the plurality of possible memory regions sizes, the target size selected to maximize the performance characteristic (i.e., the one corresponding to the best performance is selected).

At block, 208, the OS periodically reads the LL-target and updates the mix of LLPCM units 108 and HDPCM units 106. Whenever the OS decides to change the fraction X, the page table is analyzed and a number of pages mapped to a specific set of physical locations is paged to a swap device. OS issues a control command to the memory (a possible embodiment uses a memory mapped I/O) specifying the new X value and the freed physical locations. The memory controller analyzes the RT and evicts from it all pages that are known to have been freed. The OS then restarts the operations and whenever an access to an unmapped page in the RT is performed it is mapped with 2 or 4 bits per cell according to the newly specified fraction X.

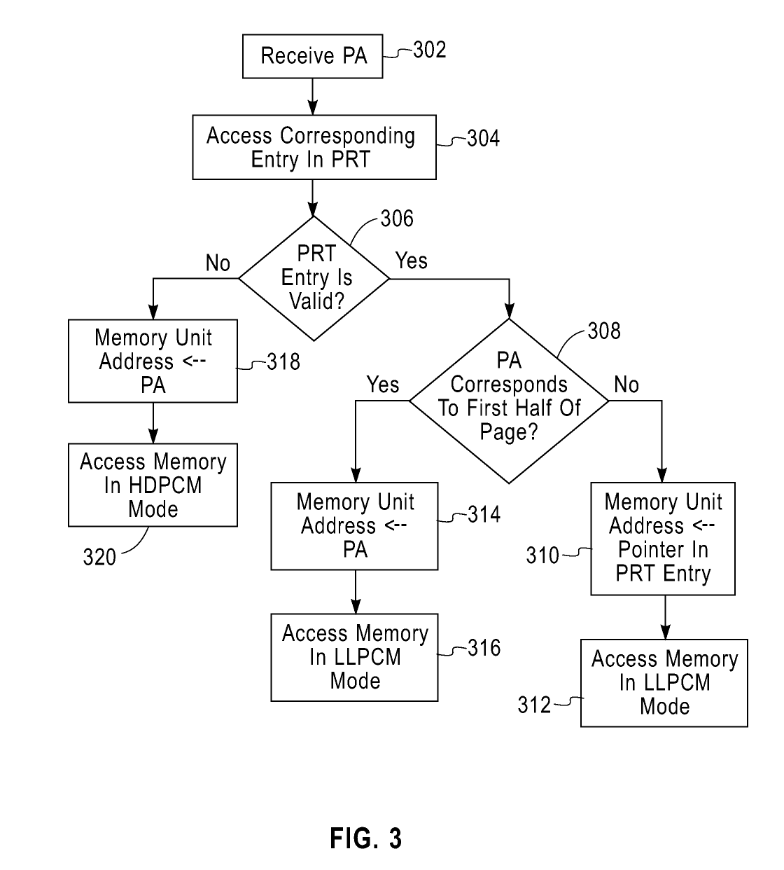

FIG. 3 illustrates a process for accessing memory in a MMS that may be implemented by an exemplary embodiment. At block 302, a physical address 116 is received at the memory system. At block 304, an entry in the PRT 110 that corresponds to the physical address 116 is accessed. At block 306, it is determined if the entry in the PRT 110 is valid. If the entry in the PRT 110 is not valid, then block 318 is performed and the physical address 116 is the memory unit address. Processing continues at block 320 where the memory at the memory unit address is accessed in HDPCM mode.

If it is determined, at block 306, that the entry in the PRT 110 is valid, then block 308 is performed to determine if the physical address 116 corresponds to a first half of a LLPCM page. If the physical address 116 corresponds to a first half of a LLPCM page, then block 314 is performed and the physical address 116 is the memory unit address. Processing continues at block 316 where the memory at the memory unit address is accessed in LLPCM mode. If the physical address 116 corresponds to a second half of a LLPCM page, as determined at block 308, then block 310 is performed and the memory unit address is an address located at a location specified by a pointer in the entry in the PRT 110. Processing continues at block 312 where the memory at the memory unit address is accessed in LLPCM mode.

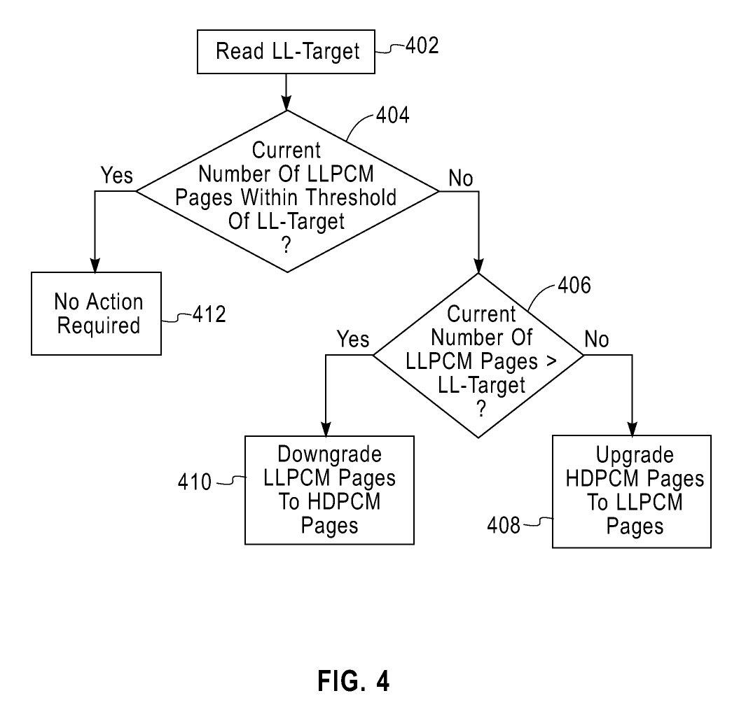

FIG. 4 illustrates a process for reaching a target percentage of lower density memory cells that may be implemented by an exemplary embodiment. In an exemplary embodiment, the process depicted in FIG. 4 is implemented by the OS. In another exemplary embodiment, the process depicted in FIG. 4 is implemented by hardware. At block 402, the LL-target 114 (also referred to herein as a target size for a memory region) is read or received by the OS. In an exemplary embodiment, the LL-target 114 is read periodically by the OS. As described previously, the LLPCM region includes memory (e.g., memory pages, memory cells) operating at one density and the HDPCM region is made up of memory operating at a different density. The memory in the LLPCM region and the memory in the HDPCM region are referred to collectively as “the memory”. At block 404 it is determined if the current number of LLPCM pages (i.e., the current size of the LLPCM region) is within a threshold (e.g., 2%, 5%, 10%) of the LL-target 114. If the current number of LLPCM pages is within the threshold of the LL-target 114, then block 412 is performed and no action is required. If the current number of LLPCM pages is not within the threshold amount of the LL-target 114, then block 406 is performed to determine if the current number of LLPCM pages is over or under the LL-target 114. If the current number of LLPCM pages is under the LL-target 114, then block 408 is performed and the OS evicts some HDPCM units 106 so that the memory pages associated with those units can be used as LLPCM units 108. Therefore, first the OS identifies a portion of the memory in the HDPCM region to reassign into the LLPCM region. The OS then performs the reassignment dynamically during normal system operation. If the current number of LLPCM pages is over the LL-target 114, then block 410 is performed and the OS evicts some LLPCM units 108 so that the memory pages associated with those units can be used as HDPCM units 106. Therefore, first the OS identifies a portion of the memory in the LLPCM region to reassign into the HDPCM region. The OS then performs to the reassignment dynamically during normal system operation. As used herein, the term reassigning refers to changing the operating density of a portion of a memory (e.g., a unit, a page, a cell) by moving the memory to a memory pool (or region) that access the memory using a different density.

In an exemplary embodiment, a balloon process is utilized to change the size of the LLPCM and HDPCM regions. A balloon process is a dummy process which can take away physical memory pages from running processes. When the OS wants to reduce the available pages, it inflates the balloon and vice versa. In MMS, the memory units associated with the pages claimed by the balloon process, are marked by the OS to be free for storing second halves of LLPCM pages. This information is communicated to the hardware using the PST 104.

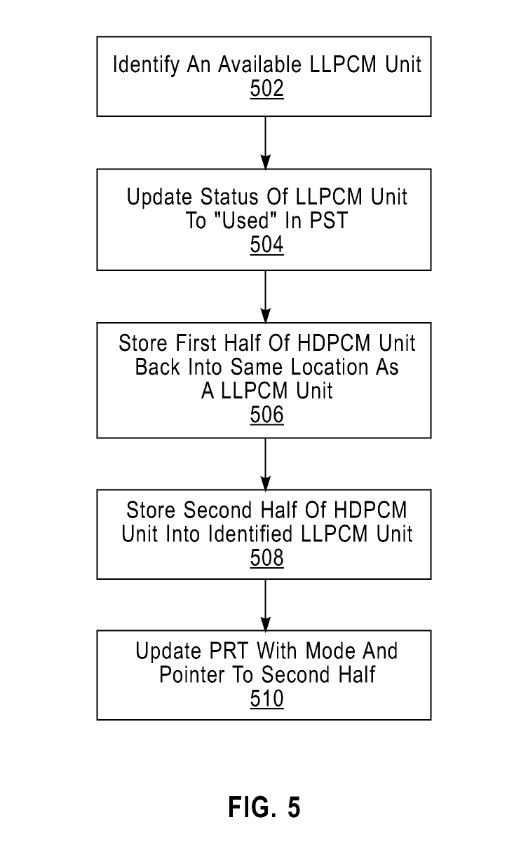

FIG. 5 illustrates a process for upgrading a memory page (i.e., moving data from a HDPCM unit 106 to a LLPCM unit 108) that may be implemented by an exemplary embodiment. At block 502, an available LLPCM unit 108 is identified (e.g., using the PST 104). At block 504, the status of the identified LLPCM unit 108 is updated to “used’ in the PST 104. At block 506, the first half of the data stored in the HDPCM unit 106 is stored back into the same memory unit address as a LPPCM unit 108. At block 508, the second half of the data from the HDPCM unit 106 is stored into the identified LLPCM unit 108. Temporary storage means, such as a queue or register, may be utilized to assist in blocks 506 and 508. At block 510, the PRT 110 is update to indicate that the data is stored in the LLPCM mode and a pointer to the identified LLPCM unit 108 is also recorded in the PRT 110.

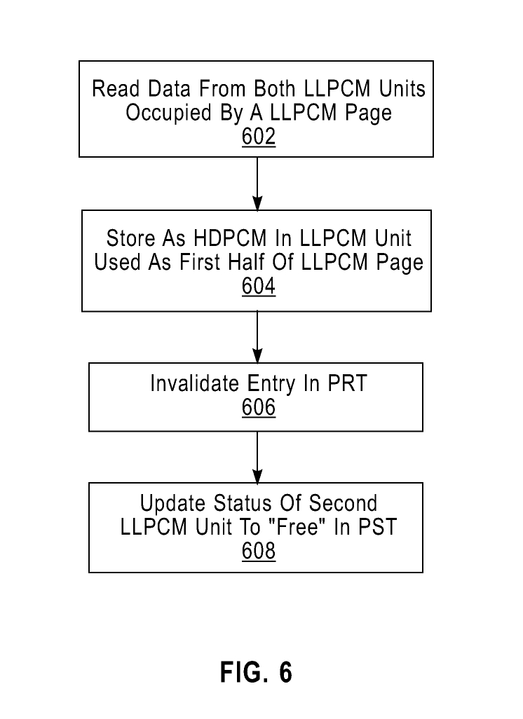

FIG. 6 illustrates a process for downgrading a memory page (i.e., moving data from a LLPCM unit 108 to a HDPCM unit 106) that may be implemented by an exemplary embodiment. A page downgrade can happen either when the page is being victimized to upgrade another page, or if the LL-target 114 is much smaller than the current number of LLPCM pages, so the hardware is trying to convert used LLPCM pages into free LLPCM pages. At block 602, the data from both LLPCM units 108 that occupy a LLPCM page are read. At block 604, the data from the LLPCM units 108 is stored, as a HDPCM unit 106 (i.e., having a higher density), back into the same memory unit address where the first half of the LLPCM data was stored. At block 606, the entry in the PRT 110 is invalidated to indicate that the memory page is a HDPCM unit 106. At block 608, the status of the second LLPCM unit 108 is updated to “free” in the PST 104.

Technical benefits of exemplary embodiments include the ability to obtain reduced latency, reduced power and increased lifetime for PCM based memory systems by reducing the bits per cell when the workload does not use all of the memory capacity in the memory system. Another benefit is that the system dynamically (e.g., during system runtime) increases the number of bits per cell when the workload is constrained by memory capacity. A further benefit is that because it is a runtime mechanism, an exemplary embodiment can outperform a memory system that statically partitions memory into different regions each with a fixed density.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed:

1. A computer implemented method for performing memory management in a memory system, the method comprising:
obtaining a target size for a first memory region, the first memory region comprising first memory units operating at a first density, the first memory units included in a memory in a memory system, the memory operable at the first density and operable at a second density;
determining that a current size of the first memory region is not within a threshold of the target size and that the first memory region is smaller than the target size;
identifying a second memory unit currently operating at the second density in a second memory region, the second memory unit included in the memory; and
dynamically reassigning, during normal system operation, the second memory unit into the first memory region, the second memory unit operating at the first density after being reassigned to the first memory region.

2. The method of claim 1, further comprising:
determining that the current size of the first memory region is not within a threshold of the target size and that the first memory region is larger than the target size; and
dynamically reassigning, during normal system operation, a portion of the first memory units into the second memory region, the portion of the first memory units operating at the second density after being reassigned to the second memory region.

3. The method of claim 1, wherein the target size is received periodically during normal system operation.

4. The method of claim 1, wherein the second memory unit is a memory page.

5. The method of claim 1, wherein the second memory unit comprises at least one memory cell.

6. The method of claim 1, wherein the obtaining, determining, identifying, and dynamically reassigning are performed by an operating system.

7. The method of claim 1, wherein the obtaining, determining, identifying, and dynamically reassigning are performed by hardware.

8. The method of claim 1, wherein the first density is two bits per memory cell and the second density is four bits per memory cell.

9. The method of claim 1, wherein the first density is one bit per memory cell and the second density is two bits per memory cell.

10. The method of claim 1, wherein the memory is a phase change memory.

11. The method of claim 1, further comprising:
obtaining a new target size for the first memory region, the obtaining comprising:
performing for a plurality of possible first memory region sizes:
estimating a probability of a processor request not being present in the memory; and
estimating a performance characteristic of the memory system in response to a latency of the first memory, a latency of the second memory, and the estimated probability of the processor request not being present in the memory; and
selecting the new target size from the plurality of possible first memory region sizes, wherein the new target size corresponds to a possible first memory region size having the highest estimated performance characteristic among the plurality of possible first memory region sizes.

12. A computer system comprising:
a memory capable of accessing data at two or more densities; and
a memory management subsystem for organizing the memory into at least two memory regions operating at different densities, the memory management subsystem receiving memory access requests from a processing unit and configured to dynamically change the size of at least one of the memory regions during normal system operation in response to characteristics of a program that is executing on the processing unit.

13. The computer system of claim 12, further comprising a memory monitor for monitoring the memory access requests, identifying a target size of at least one of the memory regions in response to the monitoring, and for outputting the target size to the memory management subsystem.

14. The computer system of claim 12, wherein the memory management subsystem is configured to reassign memory units between the two memory regions while the program is executing on the processing unit.

15. A computer program product for performing memory management, the computer program product comprising:
a tangible storage medium readable by a processing circuit and storing instructions for execution by the processing circuit for performing a method comprising:
obtaining a target size for a first memory region, the first memory region comprising first memory units operating at a first density, the first memory units included in a memory in a memory system, the memory operable at the first density and operable at a second density;
determining that a current size of the first memory region is not within a threshold of the target size and that the first memory region is smaller than the target size;
identifying a second memory unit currently operating at the second density in a second memory region, the second memory unit included in the memory; and
dynamically reassigning, during normal system operation, the second memory unit into the first memory region, the second memory unit operating at the first density after being reassigned to the first memory region.

17. The computer program product of claim 15, wherein the target size is obtained periodically during normal system operation.

18. The computer program product of claim 15, wherein the second memory unit is a memory page.

19. The computer program product of claim 15, wherein the second memory unit comprises at least one memory cell.

20. The computer program product of claim 15, wherein the obtaining, determining, identifying, and dynamically reassigning are performed by an operating system.

21. The computer program product of claim 15, wherein the obtaining, determining, identifying, and dynamically reassigning are performed by hardware.

22. The computer program product of claim 15, wherein the memory is a phase change memory.

23. The computer program product of claim 15, wherein the method further comprises:
obtaining a new target size for the first memory region, the obtaining comprising:
performing for a plurality of possible first memory region sizes:
estimating a probability of a processor request not being present in the memory; and
estimating a performance characteristic of the memory system in response to a latency of the first memory, a latency of the second memory, and the estimated probability of the processor request not being present in the memory; and
selecting the new target size from the plurality of possible first memory region sizes, wherein the new target size corresponds to a possible first memory region size having the highest estimated performance characteristic among the plurality of possible first memory region sizes.

24. A computer implemented method for performing memory management in a memory system, the method comprising:
obtaining a target size for a first memory region in a memory, the memory capable of accessing data at two or more densities, the first memory region including a first portion of the memory operating at a first density, the obtaining comprising:
performing for a plurality of possible first memory region sizes:
estimating a probability of a processor request not being present in the memory; and
estimating a performance characteristic of the memory system in response to a latency of the first portion of the memory, a latency of a second portion of the memory, and the estimated probability of the processor request not being present in the memory; and
selecting the target size from the plurality of possible first memory region sizes, wherein the target size selected corresponds to a possible first memory region size having the highest estimated performance characteristic among the plurality of possible first memory region sizes.

25. The method of claim 24, wherein the obtaining is performed during normal system operation.

26. The method of claim 24, further comprising dynamically changing the size of the first memory region in response to the target size, the dynamically changing performed during normal system operation.
